(19) United States
(12) Patent Application Publication
(10) Pub. No.: US 2006/0010298 A1
(43) Pub. Date: Jan. 12, 2006

(54) Device for controlling the flow of processes in a processor system

(75) Inventor: Antonio Romero Lobato, Schaafheim (DE)

Correspondence Address: MORRISON & FOERSTER LLP, 1650 TYSONS BOULEVARD, SUITE 300, MCLEAN, VA, 22102, US

(73) Assignee: Siemens AG, Munich (DE)

(21) Appl. No.: 11/175,400

(22) Filed: Jul. 7, 2005

(30) Foreign Application Priority Data
Jul. 8, 2004 (DE) 10 2004 033 118.9

(51) Int. Cl. G06F 12/00

(52) U.S. Cl. 711/150

(57) ABSTRACT

In a device for controlling the flow of processes in a processor system, a processing unit (1) accessing at least one memory and the at least one memory (2) have a process management device (8) between them which allows the processor (1) to access only address ranges and/or hardware macros which are associated with the respectively executed process, whose configuration is stored in the process management device (8).

The invention relates to a device for controlling the flow of processes in a processor system.

Processor systems are frequently used to control a plurality of appliances, with the processor executing appropriate programs. Particularly for reasons of security, unwanted mutual influencing of the processes needs to be prevented in this case. The risk of such errors is particularly high when various manufacturers provide processes for an overall system, which are ultimately not able to be checked fully by the system manufacturer.

A device in accordance with the invention avoids the aforementioned errors in that a processing unit accessing at least one memory and the at least one memory have a process management device between them which allows the processor to access only address ranges which are associated with the respectively executed process, whose configuration is stored in the process management device.

In this case, the processing unit may be a processor, a DMA unit, a busmaster or another programmable unit which can access the memory.

In the case of particularly security-relevant functions, “hardware macros” are often used instead of programs (software) which are executed in the processor.

In the case of another device in accordance with the invention, provision is therefore made for a processing unit accessing at least one memory and the at least one memory to have a process management device between them which allows the processor to access only hardware macros which are associated with the respectively executed process.

When both types are used, provision may also be made for the process management device to control both the access to address ranges and the access to hardware macros.

One advantageous application of the inventive device is the control of various functions in motor vehicles, where the individual processes relate to the following components, for example: air conditioning installations, speed regulation, on-board computer, tire pressure monitoring, driving light and brake light.

One advantageous refinement of the invention involves the process management device allocating address ranges in the memory such that during execution of a process the processor can access linearly organized address ranges. This allows simpler programming of the individual processes without the need for skip functions merely on account of different address ranges, for example. Hence, this refinement also simplifies the separation of the individual processes.

In another refinement in accordance with the invention, the process management device contains registers which contain the association between the address ranges and memory address ranges addressed in the respective process, and means are provided which allow the contents of the registers to be changed only by an operating system. This prevents incorrect setting of the process management device from causing processes to access address ranges in the memory which belong to other processes. It is assumed in this case that the operating system, including the associated resources, such as a task table, is operating or configured correctly.

Fail-safety is also increased by virtue of means being provided which allow a change between two processes only via an interim call to the operating system, with provision preferably being made for a change between the operating system and a further process to prompt an operating-system identifier stored in the process management device to be overwritten by the identifier of the further process.

Since the processes' need for program elements and data differs greatly from process to process, another development of the invention has provision for the registers in the process management device to be able to be scaled both in terms of size and in terms of number. This affords both vertical and horizontal scalability. In this case, vertical scalability means the management complexity for a process, and horizontal scalability means the number of processes which can be managed.

In a further development of the invention, the respective address ranges of the process can have the access rights stipulated or configured for them, and following the stipulation or configuration the access rights of the individual processes are saved by the management unit.

Exemplary embodiments of the invention are illustrated in the drawing with reference to a plurality of figures and are explained in more detail in the description below. In the figures:

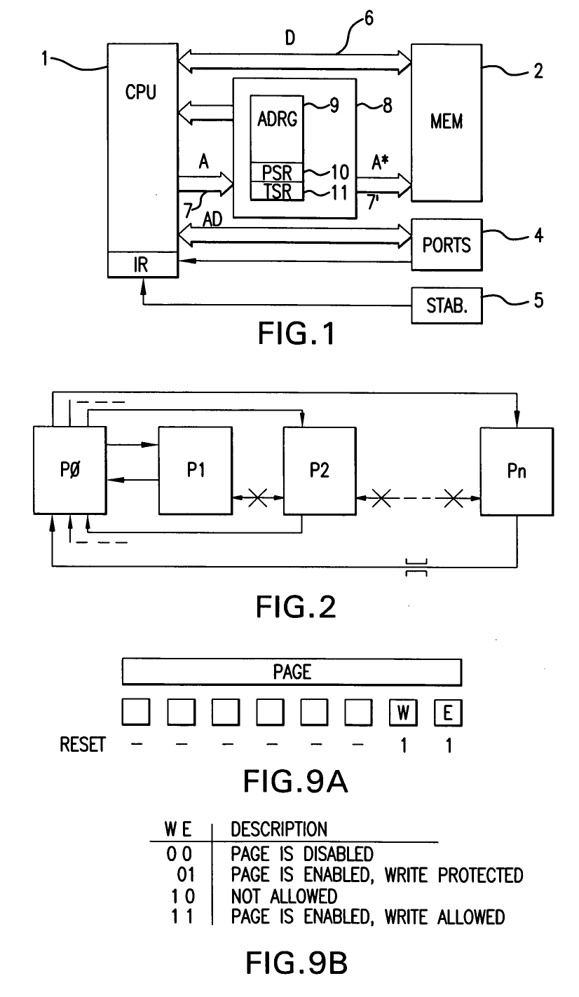

FIG. 1 shows a schematic illustration of a device in accordance with the invention,

FIG. 2 shows a schematic illustration of a plurality of processes and of the change between the processes,

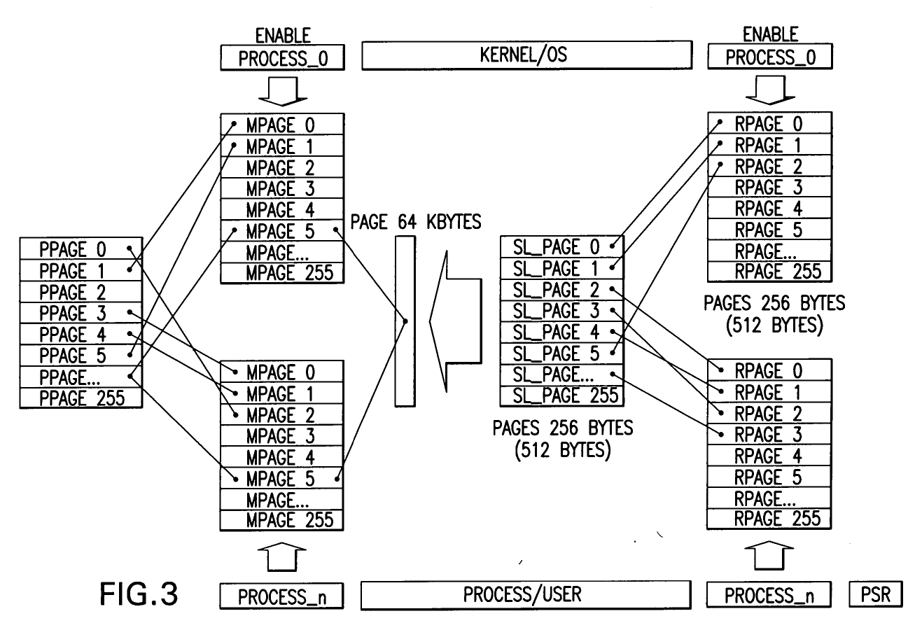

FIG. 3 shows an illustration of the association of address ranges for pages of 256 and 512 bytes,

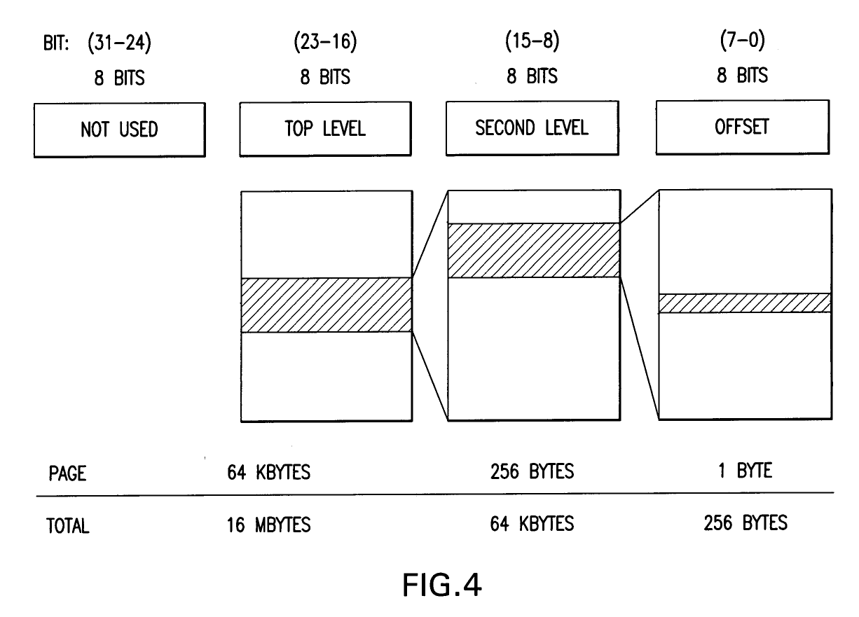

FIG. 4 shows the illustration of addresses in the case of a memory mapping structure for 64 K memories,

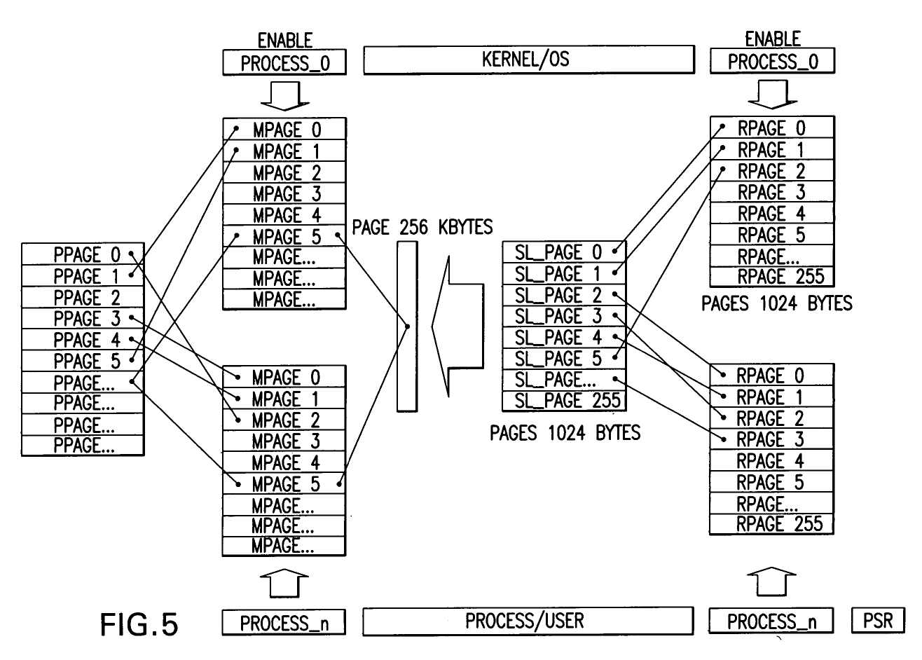

FIG. 5 shows an illustration of the association of address ranges for pages of 1024 bytes,

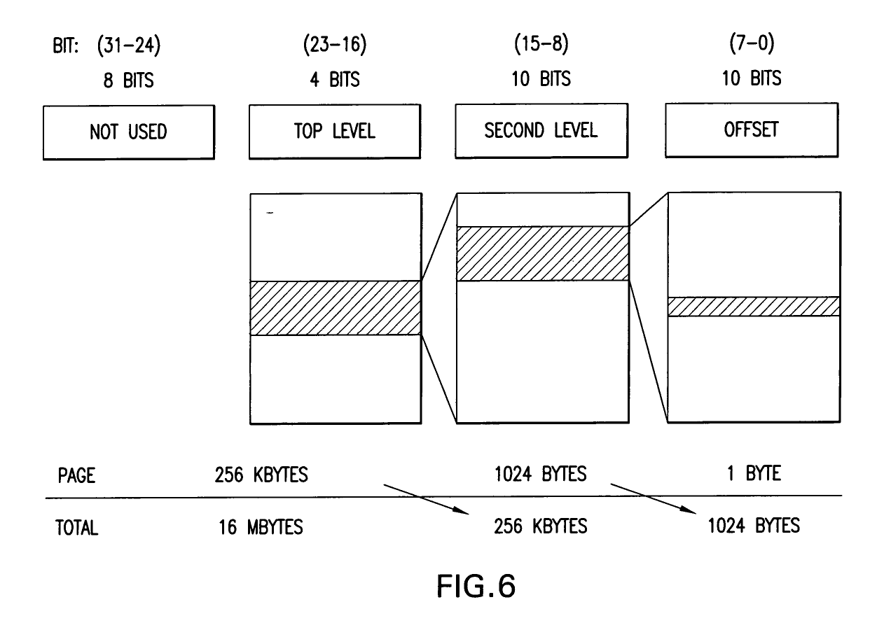

FIG. 6 shows the illustration of addresses in the case of a memory mapping structure for 256 K memories,

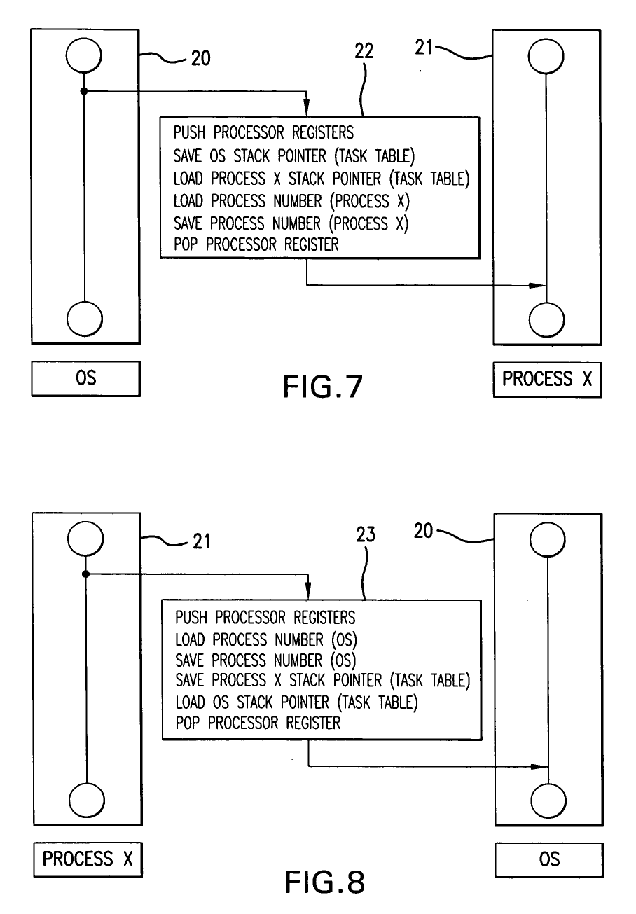

FIG. 7 shows program steps when changing over from the operating system to a process,

FIG. 8 shows program steps when changing over from a process to the operating system, and

FIG. 9 shows schematic illustrations of register contents.

FIG. 1 shows the fundamental components of a processor system which comprises a processor 1—subsequently called CPU—, a memory 2, ports 4 and a monitoring device 5. In the illustration of the memory 2, the various memories, particularly ROMs, flash-ROMs and RAMs, are combined. The CPU 1 and the memory 2 are connected to a data bus 6, in inherently known fashion. An address bus 7, 7′ has a process management device 8 switched into it, however, which, depending on the respective process which is being executed, converts the addresses A addressed by the CPU 1 into addresses A* (in a manner which is described in more detail later) and checks whether the respective addresses meet the access conditions.

The fundamental components of the process management device are the address range register (ADRG) 9, a process select register 10, which contains an identifier for the respective active process, and also a task select register 11, which contains the identifier for a respective active task.

The further components of the processor system shown in FIG. 1 do not need to be explained in more detail for an understanding of the invention. It will merely be mentioned that the ports 4 can be both input and output ports and are connected to the CPU 1 via a bus system for addresses and data. More precise connection of the monitoring device 5 is not shown for the sake of clarity. It is merely indicated that the monitoring device 5 can produce an interrupt. Since the monitoring device primarily ensures stable execution of the processes, it is denoted by STAB in FIG. 1.

FIG. 2 shows the changeover between the individual processes P1 to Pn via the operating system P0 in the form of a state diagram. Appropriate conventions ensure that the processes P1 to Pn cannot call any of the other processes, but rather only the operating system P0. In addition, changes in the address range registers 9 and in the registers 10 and 11 in the process management device 8 can be made only by the operating system P0. For the purposes of clarification, nonexistent connections between the processes P1 to Pn are identified by crosses in FIG. 2.

FIG. 3 shows a schematic illustration of the address management in the inventive processor system. In this case, address ranges—denoted by PAGE in FIG. 3—are shown both for the operating system (PROCESS_0) and for one of n processes. Registers contained in the process management device 8 (FIG. 1) contain address ranges SL_PAGEO to SL_PAGE255 as secondary level pages. The content of these registers is called by the processes, the association which exists being one which differs from the linear association. With the address ranges SL_PAGE0 to SL_PAGE255, virtual addresses for each process—MPAGE0 to MPAGE255—are used to call the physical address ranges PPAGE0 to PPAGE255. The content of the registers for the address ranges SL_PAGE0 to SL_PAGE255 is dependent on the process identifier stored in a further register PSR.

FIG. 4 shows the structure of a 32-bit address, where the first 8 bits are not needed for an address space of 16 Mbytes. The further 8 bits form a top level with a page of 64 Kbytes in each case. Taking that part of the entire address space which is addressed by these bits, 8 bits as a second level are in turn used to select one part, each page comprising 256 bytes. The last 8 bits form an offset which selects a memory location of 256 bytes from the memory locations associated with an address range.

FIG. 5 shows a similar structure for an address space of 16 Mbytes to that in FIG. 3, but for RAM pages containing 1024 bytes each. The content of such an address range is then 256 Kbytes. The structuring of an address which is required for this purpose is shown in FIG. 6. In this case, the first 8 bits are again not needed. The further 4 bits form the top level, the next 10 bits form the second level and the last 10 bits form an offset. As in the case of the address structure shown in FIG. 4, a total storage capacity of 16 Mbytes can be addressed.

FIG. 7 shows the changeover from the operating system OS to a process x, these respectively being executed as a perpendicular line between a start and end point shown symbolically as a circle. When prompted by an interrupt, the program steps combined at 22 for changing over to the process x are performed. In this case, the content of the processor register is first saved (push processor register). Next, the stack pointer of the operating system is saved in the task table, and the stack pointer of the process x is then loaded from the task table. Next, the process number of the process x is loaded and saved, and the content of the processor register of the process x is then finally read.

FIG. 8 shows the converse changeover, namely from a process x to the operating system OS via a program 23 whose execution corresponds to that of the program 22, with the variables between the operating system OS and the process x merely being the other way around. FIG. 9A schematically shows the association of a byte with a page which contains two bits for identifying the access rights to the page. The significance of the two bits is described in FIG. 9B.

1. A device for controlling the flow of processes in a processor system, where a processing unit (1) accessing at least one memory and the at least one memory (2) have a process management device (8) between them which allows the processor (1) to access only address ranges which are associated with the respectively executed process, whose configuration is stored in the process management device (8).

2. A device for controlling the flow of processes in a processor system, where a processing unit (1) accessing at least one memory and the at least one memory (2) have a process management device (8) between them which allows the processor (1) to access only hardware macros which are associated with the respectively executed process.

3. The device as claimed in claim 1, wherein the process management device (8) controls both the access to address ranges and the access to hardware macros.

4. The device as claimed claim 1, wherein the process management device (8) allocates address ranges in the memory (2) such that during execution of a process the processor (1) can access linearly organized address ranges.

5. The device as claimed in claim 1, wherein the process management device (8) contains registers (9) which contain the association between the address ranges and memory address ranges addressed in the respective process, and in that means are provided which allow the contents of the registers (9) to be changed only by an operating system.

6. The device as claimed in claim 1, wherein means are provided which allow a change between two processes (P1 . . . Pn) only via an interim call to the operating system (P0).

7. The device as claimed in claim 6, wherein a change between the operating system and a further process prompts an operating-system identifier stored in the process management device to be overwritten by the identifier of the further process.

8. The device as claimed in claim 5, wherein the registers (9) in the process management device (8) can be scaled both in terms of size and in terms of number.

9. The device as claimed in claim 5, wherein the respective address ranges of the process can have the access rights stipulated or configured for them, and following the stipulation or configuration the access rights of the individual processes are saved by the management unit.
